(19) United States
(12) Patent Application Publication
(10) Pub. No.: US 2007/0059076 A1
(43) Pub. Date: Mar. 15, 2007

(54) ELECTRONIC DEVICE AND ASSISTANCE STRUCTURE THEREOF

(75) Inventor: Yu-Wen Wei, Jiangsu Province (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Shien (TW)

(21) Appl. No.: 11/466,117

(22) Filed: Aug. 22, 2006

(30) Foreign Application Priority Data
Aug. 23, 2005 (TW) 94128818

(51) Int. Cl. B41J 19/30

(52) U.S. Cl. 400/323

(57) ABSTRACT

An electronic device includes a housing, a movable module and an assistance structure. The moveable module is mounted in the housing and moving along a direction back and forth. The assistance structure, including two magnetic elements, are respectively disposed in the housing and on the moveable module for providing a force to the moveable module when the movable module starts to be moved so as to urge the moveable module toward the direction departed from the housing.

This application claims the benefit of Taiwan Application Serial No. 094128818, filed Aug. 23, 2005, the subject matter of which is incorporated herein by reference.

### BACKGROUND OF THE INVENTION

1. Field of the Invention

The invention relates in general to an electronic device and an assistance structure thereof, and more particularly an electronic device and an assistance structure thereof for urging a movable module to move back and forth when the movable module starts to be moved.

2. Description of the Related Art

Scanners, printers, or multi-function peripherals have been considered as basic, equipment by PC users or users in the office nowadays, A movable module in those electronic devices is driven by a motor and moves back and forth to perform the function such as scanning, or ink jetting.

However, the USB 5V is usually applied to the scanner as the power, but it seriously limits the driving force of the motor so as to deteriorate the driving ability to urge the moveable module. Further, the demand of the other elements matched the moveable module are more strict in specification due to the lower power of the motor.

### SUMMARY OF THE INVENTION

In view of the foregoing, it is an object of the present invention to provide an electronic device and an assistance structure thereof capable of driving the moveable module departed from the initial position successfully by using the original power and motor because the assistance structure is able to provide a push force to the moveable module when it starts to move.

The invention achieves the above-identified object by providing an electronic device comprising a housing a moveable module and an assistance structure. The moveable module is mounted in the housing and moving along a direction back and forth. The assistance structure including two magnetic elements is respectively disposed in the housing and on the moveable module for providing a force to the moveable module so as to urge the moveable module toward the direction departed from the housing when the movable module starts to be moved.

It is another object of the invention to provide an assistance structure disposed in an electronic device, the electronic device comprising a housing and a movable module mounted in the housing and moving along a direction back and forth. The assistance structure comprises a first magnetic element and a second magnetic element. The first magnetic element is disposed in the housing. The second magnetic element is disposed on the movable module. The first and second magnetic elements are of the same magnetic polarity for providing a repulsive force when being close to each other. When the movable module is positioned at an initial position, the repulsion urges the moveable module toward a direction departed from the housing.

Other objects, features, and advantages of the invention will become apparent from the following detailed description of the preferred but non-limiting embodiments. The following description is made with reference to the accompanying drawings,

### BRIEF DESCRIPTION OF THE DRAWINGS

FIG. 1 is a diagram illustrating an electronic device whose moveable module is positioned at the initial position according to the preferred embodiment of the present invention.

FIG. 2 schematically illustrates the electronic device in the FIG. 1 when the moveable module thereof departs from the initial position.

FIG. 3 illustrates the torsions respectively provided by each piece when the moveable module starts to move according to the electronic device of the present embodiment.

### DETAILED DESCRIPTION OF THE INVENTION

The present invention provides an electronic device and an assistance structure thereof for providing a force when a movable module starts to move so as to allow the motor to urge the moveable module to depart from the initial position much easier. The present invention now will be, described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

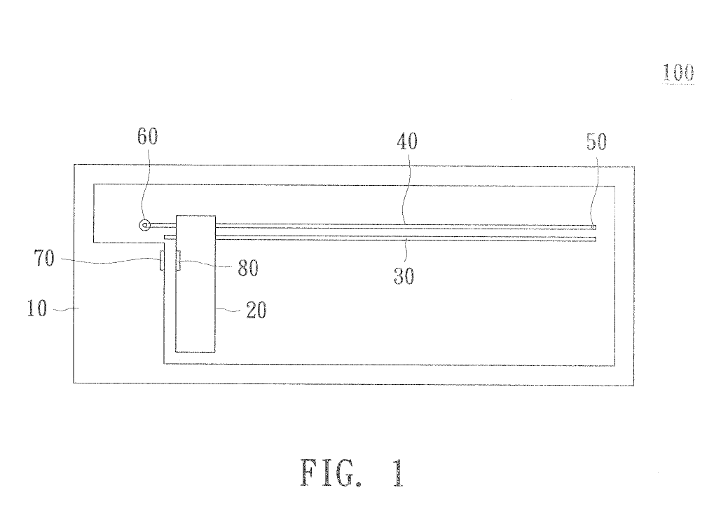

Referring to FIG. 1, which is a diagram illustrating an electronic device whose moveable module is positioned at the initial position according to the preferred embodiment of the present invention. The electronic device 100 of the present embodiment includes a housing 10, a moveable module 20, an assistance structure, a rod 30, a drive belt 40, an idle pulley 50 and motor 60. The moveable module 20 is mounted in the housing 10, and moves along a direction (i.e. the direction which the rod 30 extends) back and forth. For example, the moveable module 20 is an image sensor module for scanning the document line by line if the electronic device 100 is a scanner; the moveable module 20 is an ink cartridge for jetting the ink line by line if the electronic device 100 is a printer. Also, the electronic can be a multi-function Peripherals (MFP).

Furthermore, the rod 30 is disposed in the housing 10, and the idle pulley 50 and the motor 60 press against the drive belt 40. A part of the drive belt 40 and the rod 30 is connected to the movable module 20, so that the lovable module 20 is moved along the rod 30 when the motor 60 drives the belt 40.

The assistance structure is for providing a push force so as to assist moveable module 20 in moving along a direction when the movable module 20 starts to move. Preferably, the assistance includes two magnetic elements 70 and 80, respectively disposed in the housing 10 and the moveable module 20. These two magnetic elements 70 and 80 are of the same polarity for generating a magnetic repulsion when being close to each other. Further, these two magnetic elements 70 and 80 are preferably selected from a group consists of a magnet and an electric magnet. For example, these two magnetic elements are two magnets, two electric magnets or one magnet and one electric magnet.

Two magnetic elements are exemplified in the present embodiment, but the present invention is not limited thereto. One skilled in the art realizes that the assistance structure may be embodied in many different forms, such as elastomer (i.e. spring, bellow) respectively disposed on the housing and the moveable module.

It is noted that the assistance structure further includes another two magnetic elements, which are respectively disposed on the housing 10 near another end of the rod and or another side of the moveable module 20 for providing a push force if the movable module 20 stays at the another end of the rod 30.

Referring to FIG, 1, when the moveable module 20 is positioned at the initial position, the generated magnetic repulsion is the strongest because distance between two magnetic elements 70 and 80 is the shortest, When the moveable module 20 starts to be moved, the power supplies the motor 60 and also two magnetic elements 70 and 80 if they are electric magnets. The driving force provided by the motor 60 and repulsion provided by two magnetic elements 70 and 80 synchronously urging the moveable module 20 to move.

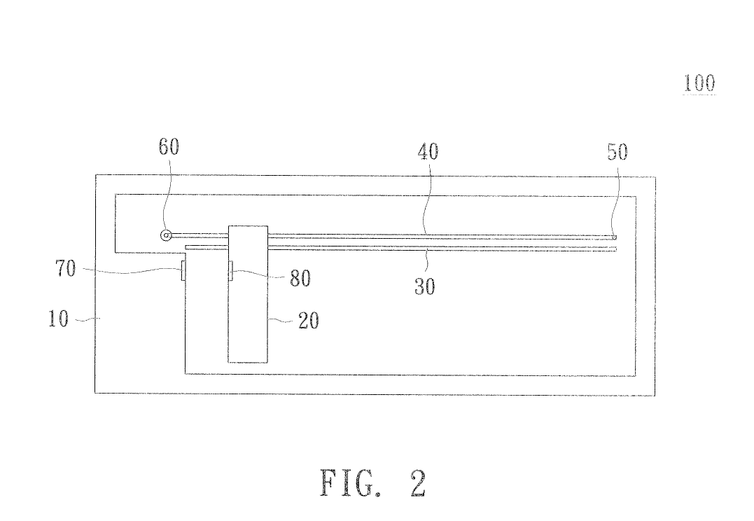

FIG. 2 schematically illustrates the electronic device in the FIG. 1 when the moveable module thereof departs from the initial position. After the moveable module 20 departs from the initial position, the magnetic repulsion is getting weak as the distance between two magnetic elements is getting long, so that the push force applied on the moveable module is also weaker.

There are several experimental results are listed below to exhibit the driving efficiency of the electronic device and assistance structure thereof.

Experiment One—Torsion

The minimum of torsion needed to drive the movable module is measured. The torsion provided by the motor and the assistance structure of the present embodiment are respectively measured. In this experiment, the scanner BenQ 5250C with dia 35 mm 5V motor and 17×10×3 magnets as the assistance structure will be provided as the tested object.

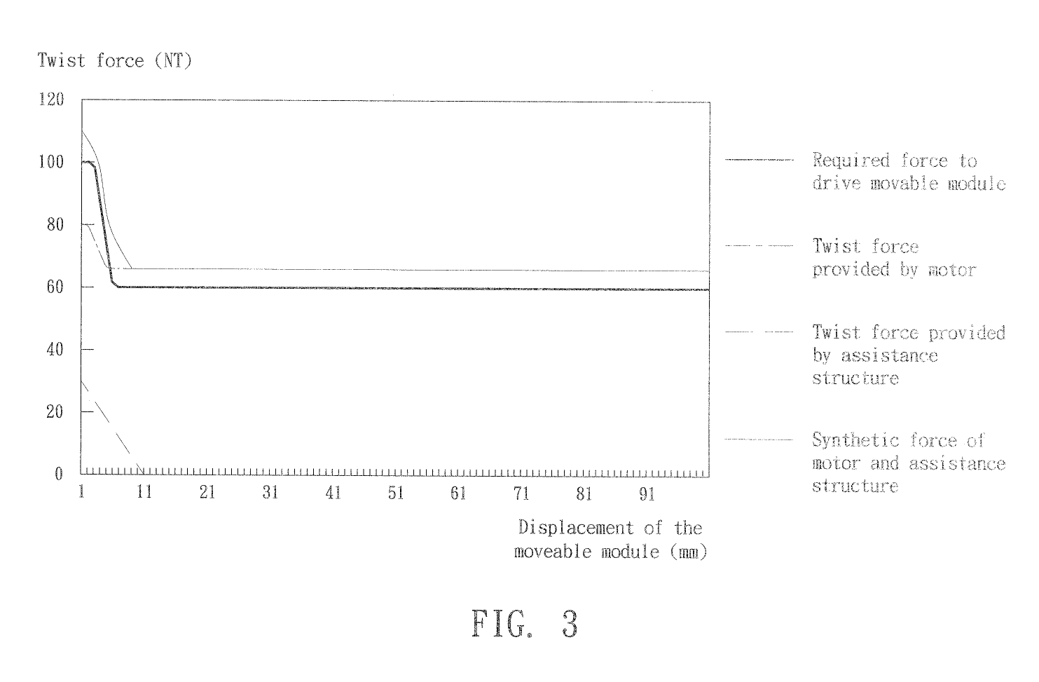

The tested data is plotted in FIG. 3, which illustrates the torsions respectively provided by each piece when the moveabie module stars to move according to the electronic device of the present embodiment In this scanner, the torsion needed to drive the moveable module to move from stationary phase to the movement phase is up to 100 Newton, but the torsion needed to keep the moveable module in the movement phase is merely 60 Newton. However, the present motor which outputs the torsion of 80 Newton only fails to drive the moveable module without assistance structure.

After mounting an assistance structure (i.e.17×10×3 magnet) which provides additional torsion of 30 Newton, the motor and assistance structure synchronously output about a torsion of about 110 Newton so as to successfully drive the moveable module. Although the repulsion between two magnets becomes weak when the moveable modules departs from the initial position, only the motor itself which provides the torsion of 80 Newton is able to drive the moveable module which needs torsion of 60 Newton only. Accordingly, the assistance structure indeed offers a function to help the motor drive the moveable module.

As described hereinbefore, the electronic device and the assistance structure thereof of the present invention has many advantages as follow. The assistance structure offering an additional force helps the motor drive the moveable module to depart from the initial position much easier. Further, the assistance structure can be widely applied to the printer, the scanner, the multi-function peripheral all of which have been considered as basic equipments of office nowadays. Besides, if the assistance structure has been equipped in the electronic device, the specification of the motor can be downgraded, and the predetermined distance for moveable module to accelerate as a buffer region will also be decreased. It allows to shrink the size of the motor and the electronic device, decrease the cost, and raise the reliability.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures,

What is claimed is:

1. An electronic device comprising:
a housing;
a moveable module, mounted in the housing and moving along a direction back and forth; and
an assistance structure including two magnetic elements, respectively disposed in the housing and on the moveable module for providing a force to the moveable module so as to urge the moveable module toward the direction departed from the housing when the movable module starts to be moved.

2. The electronic device according to claim 1, wherein the two magnetic elements are of the same magnetic polarity so as to generate a magnetic repulsion.

3. The electric device according to claim 1, wherein the two magnetic elements are selected from a group consist of a magnet and an electric magnet.

4. The electronic device according to claim 1, wherein the electronic device is a scanner, and the movable module is an image sensormodule.

5. The electronic device according to claim 1, wherein the electronic device is a printer, and the movable module is an ink cartridge.

6. The electronic device according to claim 1, wherein the electronic device is a multi-function Peripherals (MFP).

7. The electronic device according to claim 1, wherein the assistance structure is an elastomer disposed on the housing or the movable module.

8. An assistance structure disposed in an electronic device, the electronic device comprising a housing and a movable module mounted in the housing and moving along a direction back and forth, the assistance structure comprising:
a first magnetic element, disposed in the housing; and
a second magnetic element, disposed on the movable module;
wherein the first and second magnetic elements are of the same magnetic polarity for providing a repulsion when being close to each other, when the movable module is positioned at an initial position, the repulsion urges the moveable module toward a direction departed from the housing.

9. The assistance structure according to claim 8, wherein the first and second magnetic elements are selected from a group consist of a magnet and an electric magnet.

10. The assistance structure according to claim 8, wherein the electronic device is a scanner, and the movable module is an image sensor module.

11. The assistance structure according to claim 8, wherein the electronic device is a printer, and the movable module is an ink cartridge.

12. The assistance structure according to claim 8, wherein the electronic device is a multi-function Peripherals (MFP).
